(19) United States
(12) Patent Application Publication
(10) Pub. No.: US 2009/0293697 A1
(43) Pub. Date: Dec. 3, 2009

(54) SAFETY CUTTING RULE

(76) Inventor: SHAO-TSUNG WEI, Yunghe City (TW)

Correspondence Address: LEONG C LEI, PMB # 1008, 1867 YGNACIO VALLEY ROAD, WALNUT CREEK, CA, 94598, US

(21) Appl. No.: 12/129,705

(22) Filed: May 30, 2008

(51) Int. Cl. B26D 5/00

(52) U.S. Cl. 83/745

(57) ABSTRACT

A safety cutting rule includes a rule body marked with distance-measuring graduations, a protective plate pivoted to the rule body and turnable relative to the rule body between a collapsed position where the protective plate is stacked on the rule body and a lifted position where the protective plate defines with the rule body a contained angle for protecting the hand that holds down the sheet to be cut and preventing hand injury.

### BACKGROUND OF THE INVENTION

(a) Technical Field of the Invention

The present invention relates to a cutting rule and more particularly, to a safety cutting rule, which prevents hand injury during a cutting operation.

(b) Description of the Prior Art

Rule is a straight strip of wood, metal, etc., used to measure or as a guide in drawing or cutting. When using a cutter to cut a sheet material and a rule to guide the cutter in cutting the sheet material, the operator's hand may be injured by the cutting edge of the cutter accidentally. Therefore, it is desirable to provide a safety cutting rule that prevents hand injury.

### SUMMARY OF THE INVENTION

The primary purpose of the present invention is to provide a safety cutting rule, which prevents hand injury when guiding a cutter to cut a sheet material.

To achieve this and other objects and according to one embodiment of the present invention, a safety cutting rule comprises a rule body marked with distance-measuring graduations, and a protective plate oblique protruded from and extending along one long side of the rule body.

In an alternate form of the present invention, the protective plate is pivotally connected to the rule body near one long side of the rule body and turnable relative to the rule body between a collapsed position where the protective plate is closely attached to the top wall of the rule body and a lifted position where the protective plate defines with the rule body a contained angle. Preferably, the contained angle is within 65°˜75°.

Further, the rule body and the protective plate are respectively marked with distance-measuring graduations.

Further, positioning structure may be provided to hold the protective plate in the collapsed or lifted position. The positioning structure may be variously embodiment. In one embodiment of the present invention, hooks are protruded from the top wall of the rule body for hooking the protective plate in the collapsed position. In another embodiment of the present invention, flat braces are respectively inserted through respective slots on the protective plate and connected between the top edge of the longitudinal stop flange and the top wall of the rule body. Each flat brace has a lower stop bead for stopping the protective plate in the collapsed position, and an upper stop bead for stopping the protective plate in the lifted position.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an elevational view of a safety cutting rule in accordance with a first embodiment of the present invention.

FIG. 2 corresponds to FIG. 1, showing the protective plate in the lifted position.

FIG. 3 is an applied view of the safety cutting rule according to the first embodiment of the present invention.

FIG. 4 is an elevational view of a safety cutting rule in accordance with a second embodiment of the present invention.

FIG. 5 corresponds to FIG. 4, showing the protective plate in the lifted position.

FIG. 6 is an applied view of the safety cutting rule according to the second embodiment of the present invention.

FIG. 7 is an elevational view of a safety cutting rule in accordance with a third embodiment of the present invention.

FIG. 8 corresponds to FIG. 7, showing the protective plate in the lifted position.

FIG. 9 is an end plain view of the third embodiment of the present invention, showing the protective plate in the collapsed position.

FIG. 10 is another end plain view of the third embodiment of the present invention, showing the protective plate in the lifted position.

FIG. 11 is an end plain view of a safety cutting rule in accordance with a fourth embodiment of the present invention, showing the protective plate in the collapsed position.

FIG. 12 is another end plain view of the fourth embodiment of the present invention, showing the protective plate in the lifted position.

FIG. 13 is an elevational view of a safety cutting rule in accordance with a fifth embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

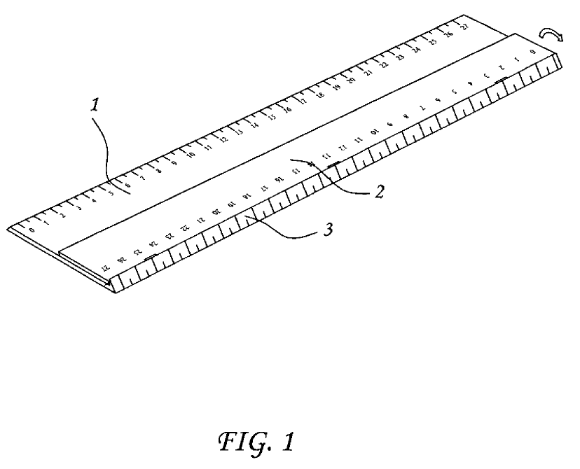

Referring to FIGS. 1-3, a safety cutting rule in accordance with a first embodiment of the present invention is shown comprising a rule body 1 and a protective plate 2. The rule body 1 has a predetermined length, a first long side, a second long side opposing the first long side, and a longitudinal stop flange 3 obliquely upwardly protruded from the first long side and extending along the length and defining with the top wall of the rule body 1 a contained angle. The contained angle is preferably within 65°˜75°. The longitudinal stop flange 3 can be made having a length equal to the length of the rule body 1. Alternatively, the longitudinal stop flange 3 can be made having a length shorter than the rule body 1. According to this embodiment, the longitudinal stop flange 3 has a length equal to the length of the rule body 1. Further, distance-measuring graduations are marked on the longitudinal stop flange 3. The longitudinal stop flange 3 may also be marked with distance-measuring graduations.

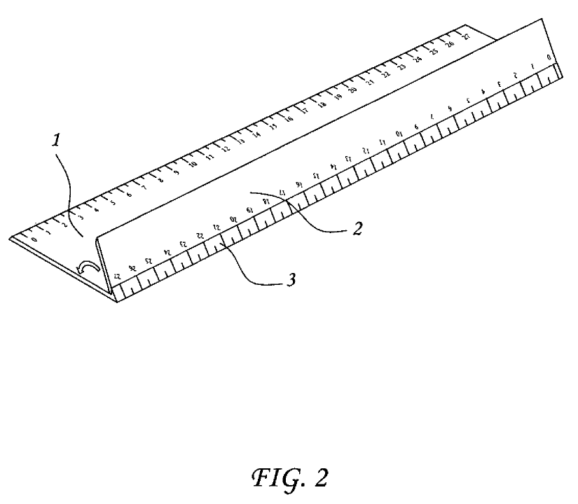

The protective plate 2 is a an elongated flat strip hinged to the top wall of the rule body 1 near the first long side of the rule body 1, and can be turned between a collapsed position where the protective plate 2 is closely attached to the top wall of the rule body 1 and kept in parallel to the rule body 1 (see FIG. 1) and a lifted position where the protective plate 2 is abutted against one side, namely, the inner side of the longitudinal stop flange 3 (see FIG. 2).

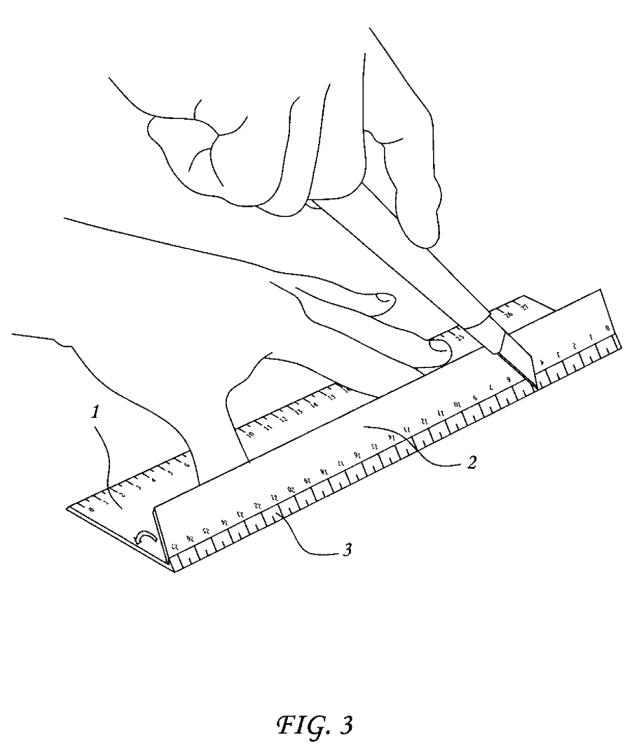

Referring to FIG. 3 again, when the safety cutting rule of the first embodiment of the present invention is in use, lift the protective plate 2 to the lifted position, and then hold down the rule body 1 on the sheet to be cut with one hand, and then move the cutter along the longitudinal stop flange 3 with the other hand pad to cut the sheet. Because the protective plate 2 shields the hand that holds down the rule body 1, the user can cut the sheet safely.

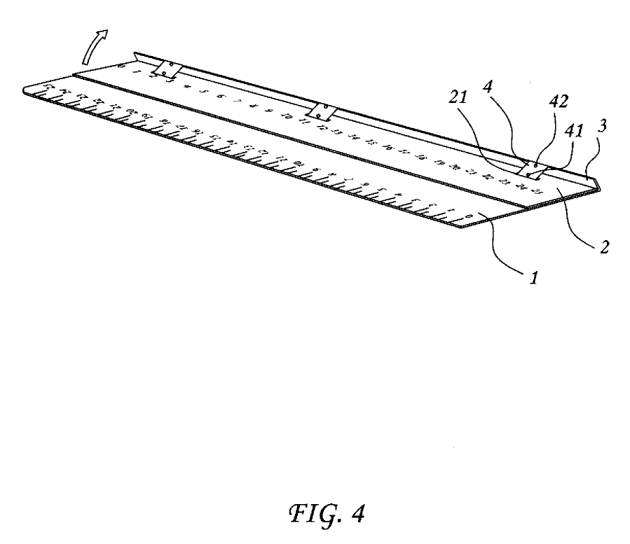

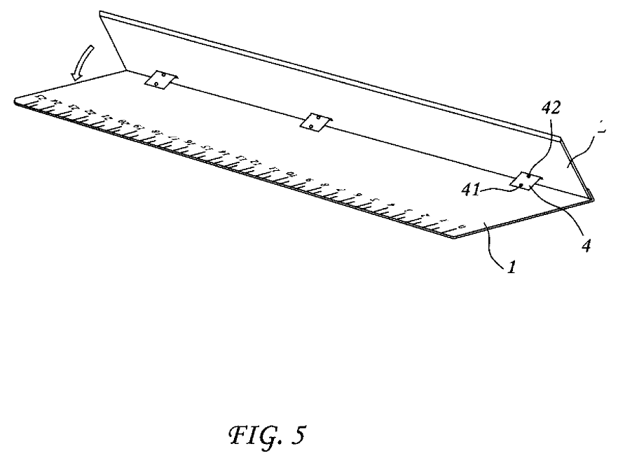

FIGS. 4˜6 show a safety cutting rule in accordance with a second embodiment of the present invention. According to this second embodiment, the safety cutting rule comprises a rule body 1, which has a first long side, a second long side opposing the first long side, a longitudinal stop flange 3 obliquely upwardly protruded from the first long side and extending along the length, a plurality of flat braces 4 fixedly connected between the top edge of the longitudinal stop flange 3 and the top wall of the rule body 1, each flat brace 4 having a lower stop bead 41 and an upper stop bead 42 respective raised from the upper wall, and a protective plate 2 hinged to the top wall of the rule body 1 near the first long side of the rule body 1 and having a plurality of slots 21 for the passing of the flat braces 4 respectively before connection of the flat braces 4 between the longitudinal stop flange 3 and the rule body 1. The protective plate 2 can be turned between a collapsed position where the protective plate 2 is closely attached to the top wall of the rule body 1 and kept in parallel to the rule body 1 and the lower stop beads 41 are respectively stopped against the respective top side edge of each of the slots 21 to hold the longitudinal stop flange 3 steadily in the collapsed position (see FIG. 4) and a lifted position where the protective plate 2 is abutted against the inner surface of the longitudinal stop flange 3 and the upper stop beads 42 are respectively stopped against the respective top side edge of each of the slots 21 to hold the longitudinal stop flange 3 steadily in the lifted position (see FIG. 5).

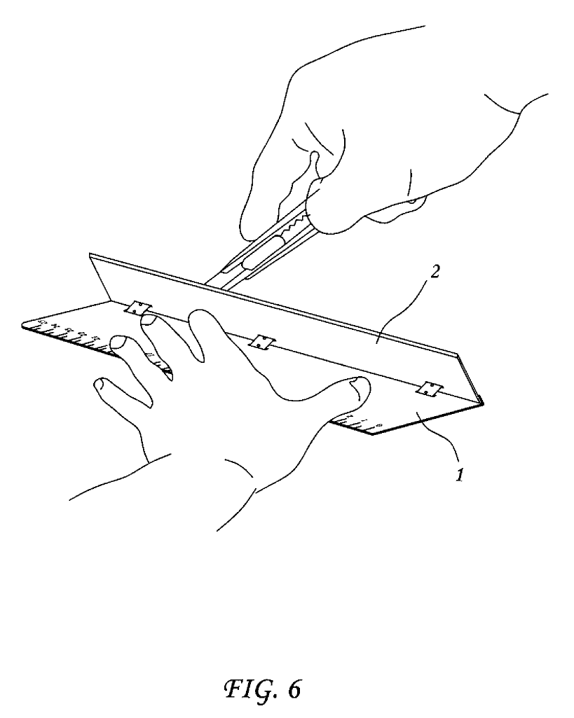

Referring to FIG. 6 again, when the safety cutting rule of the second embodiment of the present invention is in use, lift the protective plate 2 to the lifted position, and then hold down the rule body 1 on the sheet to be cut with one hand, and then move the cutter along the longitudinal stop flange 3 with the other hand pad to cut the sheet. Because the protective plate 2 shields the hand that holds down the rule body 1, the user can cut the sheet safely.

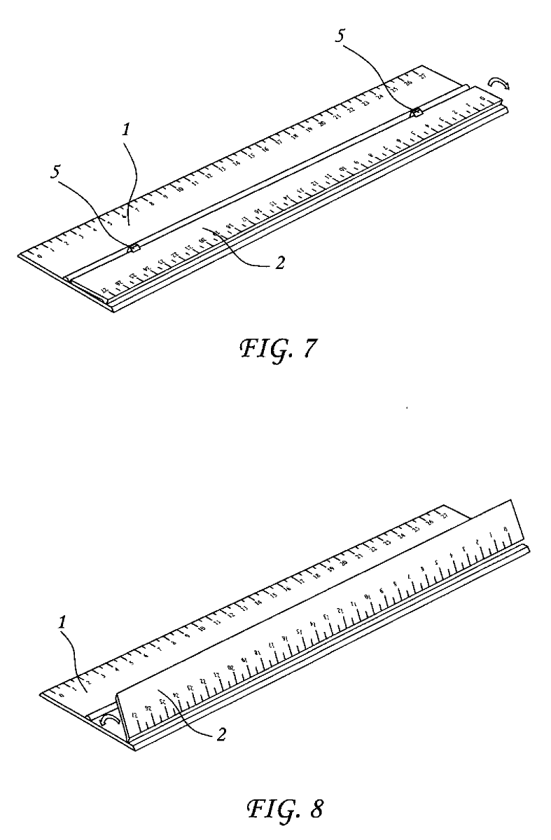

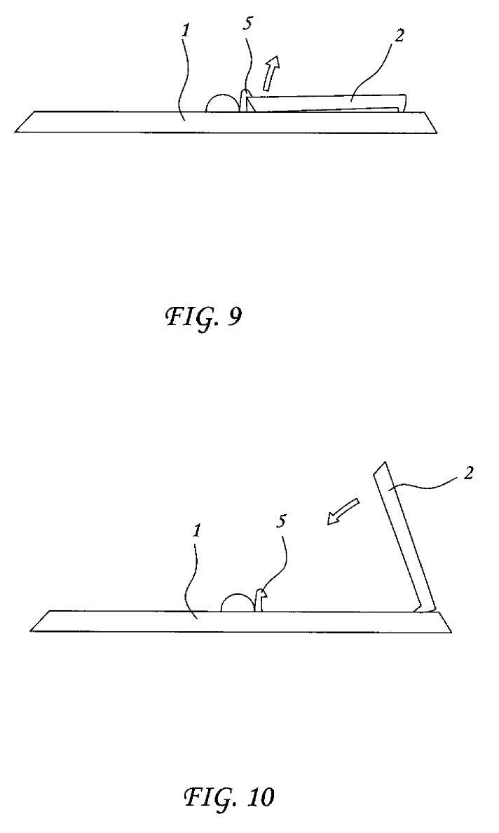

FIGS. 7˜10 show a safety cutting rule in accordance with a third embodiment of the present invention. According to this third embodiment, the safety cutting rule comprises a rule body 1, which has a first long side and a second long side opposing the first long side, a plurality of hooks 5 protruded from the top wall of the rule body 1 and aligned in a line along the length of the rule body 1 between the first long side and second long side of the rule body 1, a protective plate 2 hinged to the top wall of the rule body 1 in proximity to the first long side of the rule body 1 and turnable relative to the rule body 1 between a collapsed position where the protective plate 2 is closely attached to the top wall of the rule body 1 and held in place by the hooks 5 (see FIGS. 7 and 9) and a lifted position where the bottom edge of the protective plate 2 is stopped against the top wall of the rule body 1 and the protective plate 2 defines with the rule body 1 a contained angle, which is preferably within 65°˜75° (see FIGS. 8 and 10).

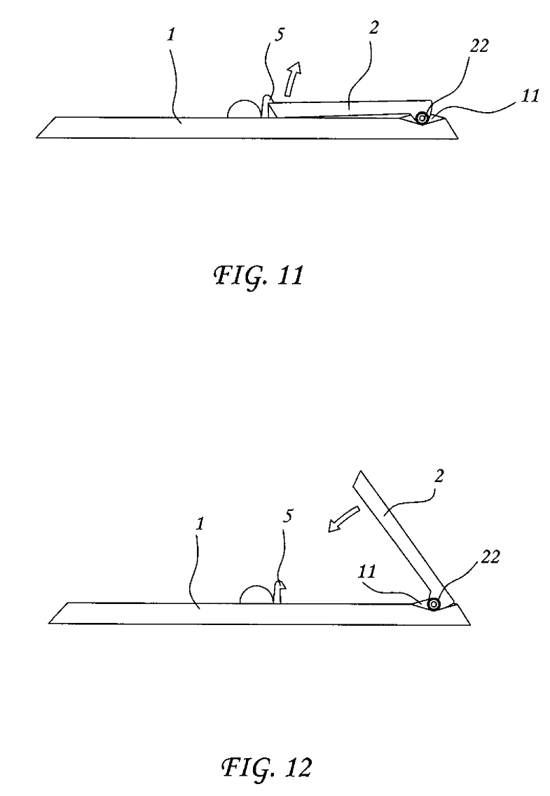

FIGS. 11˜12 show a safety cutting rule in accordance with a fourth embodiment of the present invention. According to this fourth embodiment, the safety cutting rule comprises a rule body 1, which has a first long side, a second long side opposing the first long side, and a longitudinal groove 11 on the top wall near the first long side, a plurality of hooks 5 protruded from the top wall of the rule body 1 and aligned in a line along the length of the rule body 1 between the first long side and second long side of the rule body 1, a protective plate 2, which has a bottom flange 22 pivotally connected to the longitudinal groove 11 of the rule body 1. The protective plate 2 can be turnable relative to the rule body 1 between a collapsed position where the protective plate 2 is closely attached to the top wall of the rule body 1 and held in place by the hooks 5 (see FIG. 11) and a lifted position where the bottom flange 22 of the protective plate 2 is stopped against the peripheral wall of the longitudinal groove 11 of the rule body 1 to hold the protective plate 2 in place and the protective plate 2 defines with the rule body 1 a contained angle, which is preferably within 65°˜75° (see FIG. 12).

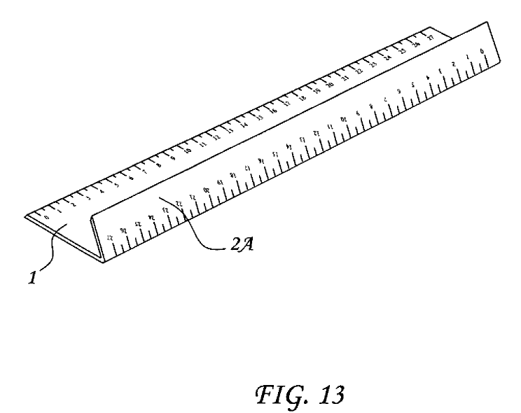

FIG. 13 illustrates a safety cutting rule in accordance with a fifth embodiment of the present invention. According to this fifth embodiment, the safety cutting rule comprises a rule body 1 and a protective plate 2A obliquely upwardly protruded from one long side of the rule body 1 and extending along the length of the rule body 1. The protective plate 2A defines with the top wall of the rule body 1 a contained angle. The contained angle is preferably within 65°˜75°.

Although particular embodiments of the invention have been described in detail for purposes of illustration, various modifications and enhancements may be made without departing from the spirit and scope of the invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A safety cutting rule comprising:
a rule body, said rule body having a top wall, a first long side, and a second long side opposing said first long side; and
a protective plate pivoted to the top wall of said rule body in proximity to said first long side and turnable relative to said rule body within a predetermined angle between a collapsed position where said protective plate is stacked on said rule body and a lifted position where said protective plate defines with said rule body a contained angle.

2. The safety cutting rule as claimed in claim 1, said rule body comprises a stop flange obliquely upwardly protruded from said first long side for stopping said protective plate in said lifted position.

3. The safety cutting rule as claimed in claim 1, said rule body and said protective plate are respectively marked with a set of distance-measuring graduations.

4. The safety cutting rule as claimed in claim 2, said rule body comprises a plurality of flat braces connected between a top edge of said stop flange and the top wall thereof, each said flat brace having a top side, a lower bead raised from the top side for stopping said protective plate in said collapsed position, and an upper bead raised from the top side for stopping said protective plate in said lifted position; said protective plate has a plurality of slots for the passing of said flat braces respectively.

5. The safety cutting rule as claimed in claim 1, said rule body comprises a plurality of hooks protruded from the top wall thereof for securing said protective plate in said collapsed position.

6. The safety cutting rule as claimed in claim 1, wherein said rule body comprises a longitudinal groove on the top wall thereof; said protective plate has a bottom flange pivoted to said longitudinal groove of said rule body, said bottom flange being stopped against a peripheral wall of said groove to hold said protective plate in position when said protective plate is turned to said lifted position.

7. The safety cutting rule as claimed in claim 1, wherein said contained angle is within 65°˜75°.

8. A safety cutting rule comprising a rule body, said rule body having a first long side, a second long side opposing said first long side, and distance-measuring graduations marked thereon, and a protective plate obliquely upwardly protruded from said first long side and extending along the length of said rule body.

9. The safety cutting rule as claimed in claim 8, wherein said protective plate defines with said rule body a contained angle within 65°˜75°.

10. The safety cutting rule as claimed in claim 8, wherein protective plate has distance-measuring graduations marked thereon.
